(19) United States
(12) Patent Application Publication
(10) Pub. No.: US 2019/0160696 A1
(43) Pub. Date: May 30, 2019

(54) KNIFE WITH CUTOUT ON SPINE

(71) Applicant: Shane Keng, Marietta, GA (US)

(72) Inventor: Shane Keng, Marietta, GA (US)

(21) Appl. No.: 16/200,342

(22) Filed: Nov. 26, 2018

Related U.S. Application Data
(60) Provisional application No. 62/591,973, filed on Nov. 29, 2017.

(51) Int. Cl. B26B 1/04

(52) U.S. Cl. CPC B26B 1/04; B26B 9/00

(57) ABSTRACT

A knife is provided. The knife includes a blade with a first end, a second end, a top portion, and an opposed bottom portion. A spine is disposed on along the top portion, and a cutout is disposed on the spine.

### CROSS-REFERENCE TO RELATED APPLICATIONS

This application claims the benefit of and priority to U.S. Provisional Application No. 62/591,973, filed on Nov. 29, 2017, which is incorporated by reference herein in its entirety.

### FIELD OF THE DISCLOSURE

The disclosure generally relates to knives and more particularly relates knives with one or more cutouts on the spine.

### BACKGROUND

A knife is a tool with a cutting edge or blade, hand-held or otherwise, with most having a handle. Some types of knives are used as utensils, including knives used at the dining table (e.g., butter knives and steak knives) and knives used in the kitchen (e.g., paring knife, bread knife, cleaver). Many types of knives are used as tools, such as the combat knife carried by soldiers, the pocket knife carried by hikers, and the hunting knife used by hunters.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a side view of a knife in accordance with one or more embodiments of the disclosure.

FIG. 2 depicts a side view of a blade in accordance with one or more embodiments of the disclosure.

FIG. 3 depicts a top view of a blade in accordance with one or more embodiments of the disclosure.

FIG. 4 depicts a side view of a knife in an open position in accordance with one or more embodiments of the disclosure.

FIG. 5 depicts a side view of the knife in a closed position in accordance with one or more embodiments of the disclosure.

### DETAILED DESCRIPTION

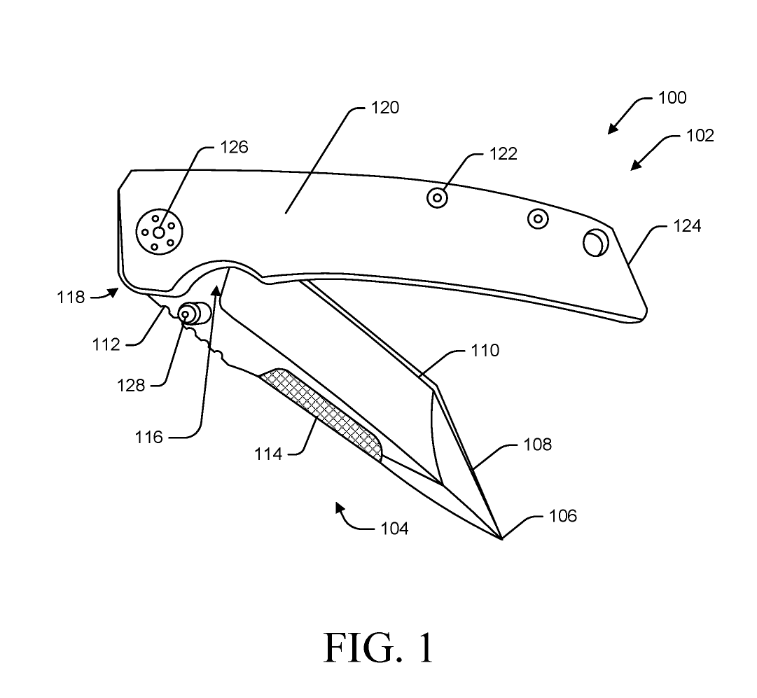

FIG. 1 depicts a knife 100. The knife 100 is divided into two main parts, the handle 102 and the blade 104. Each of these two parts can also be subdivided into subparts. For example, the point 106 is the part of the knife 100 where the edge and spine come together. The point 106 is often used for piercing. The tip 108 is the forward part of the knife 100 and includes the knife point. The tip 108 is used detailed or delicate cutting. The edge 110 is the cutting part of the blade 104. The edge 110 extends from the point 106 to the heel of the knife 100. The heel 112 is the rear part of the edge 110, opposite the point 106. The spine 114 is the top of the knife blade, opposite the knife edge 110. The bolster 116 is the band that joins the blade 102 of the knife 100 to its handle 102. The bolster 116 provides balance for the knife 100 and also helps to protect the hand from getting in the way of the knife edge. The tang 118 is the part of the blade 104 that extends into the handle 102 of the knife 100. The tang 118 is the surface to which the handle 102 attaches to the blade 104. The scales 120 are the part of the knife 100 that creates the handle 102. Scales 120 are often made of synthetic material or wood. Two scales are typically attached to the tang 118 with rivets. The rivets 122 are metal pins used to join the scales 120 to the tang 118 to form the handle 102. The butt 124 is the end of the handle 102 of the knife 100. In some instances, the knife 100 may be foldable. That is, the blade 104 may be folded into a slot in the handle 102.

In some embodiments, as shown in FIG. 1, the blade 104 includes a first end 140, a second end 142, a top portion 144, and an opposed bottom portion 146. In some instances, the tip 108 may be disposed on the first end 140 of the blade. The spine 114 may be disposed on the top portion 144. The edge 110 may be disposed on the opposed bottom portion 146.

In some embodiments, the blade 104 includes a gripped surface 156 disposed towards the second end 142 on the spine 114. In some instances, the gripped surface 156 may be a series of indentions, knurling, or other frictional surface.

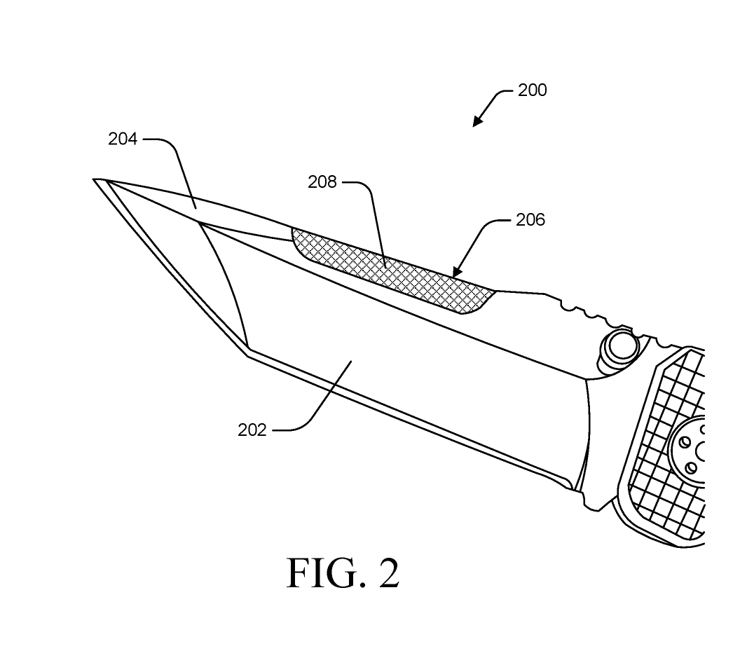

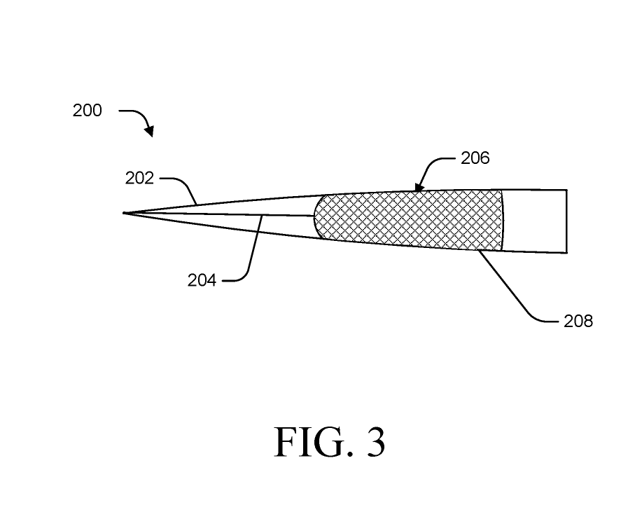

FIGS. 2 and 3 partially depict a knife 200. In some instances, the knife 200 may be similar to the knife 100. The knife 200 may include additional components or certain components may be omitted. The knife 200 may be foldable. In any case, the knife 200 may include a blade 202 having a spine 204 with a cutout 206. The cutout 206 may be located on a top portion of the spine 204. The cutout 206 may extend from the point to the heel or anywhere in-between. The cutout 206 may be any suitable size, shape, or configuration. The cutout 206 may improve the weight distribution of the knife 200 by shifting the balance point of the knife 200 further back towards the handle. The cutout 206 also may provide an optional storage area for something like a waterproof match or the like. Any item may be stored within the cutout 206.

In some instances, a storage compartment may be located in the cutout 206. In certain embodiments, the storage compartment may include an access door. In other embodiments, the storage compartment may be removable from the cutout 206. The storage compartment may correspond to the size and shape of the cutout 206. The storage compartment may be any suitable size, shape, or configuration.

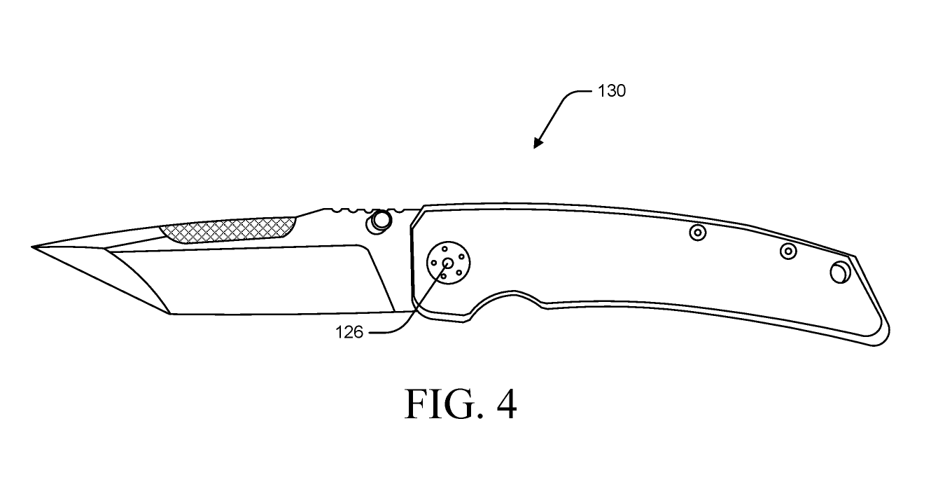

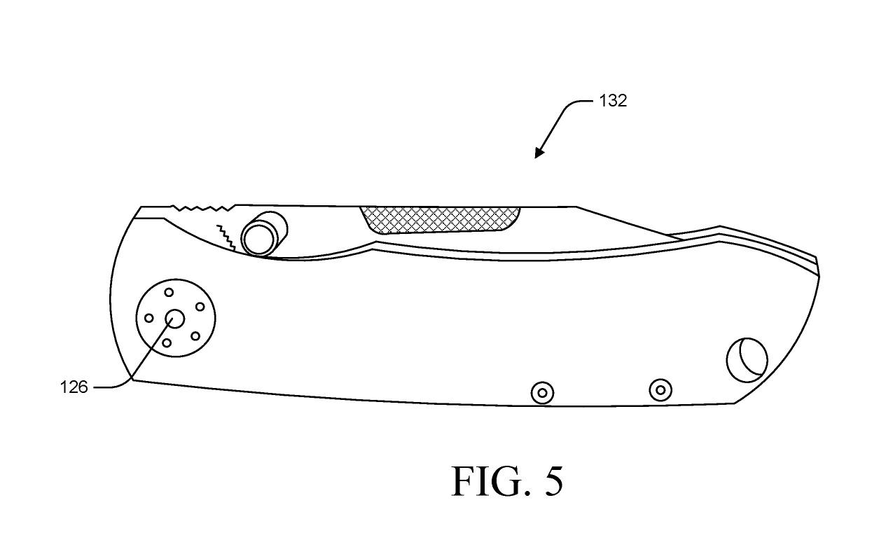

In some embodiments, as shown in FIG. 1, the knife 100 includes a pivot point 126. In some instances, the pivot point 126 may be a fastener securing the blade 104 within the handle 102. In this manner, the blade 104 may rotate about the pivot point 126 between an open position 130 (e.g., as shown in FIG. 4) and a closed position 132 (e.g., as shown in FIG. 5).

In some embodiments, as shown in FIG. 1, the knife 100 includes and adjustment post 128. The adjustment post 128 may be a protruding fastener, detent, or other structure extending perpendicularly away from the blade 104. In this manner, the adjustment post 128 may help a user to move the blade between the closed position 132 to the open position 130.

In some instances, the shaded area in FIGS. 2 and 3 may represent a trim piece/fascia 208. The trim piece/fascia 208 may be located within the cutout 206. The trim piece/fascia 208 may be lighter than the material of the blade 202. The trim piece/fascia 208 may be any suitable material. For example, the trim piece 208 may be composed of plastic or carbon fiber. In addition, the trim piece/fascia 208 may be any suitable size, shape, or configuration. The cutout 206 and the trim piece/fascia 208 may improve the weight distribution of the knife 200 by shifting the balance point of the knife 200 further back towards the handle relative to a solid blade without the cutout 206 and trim piece/fascia 208. The trim piece/fascia 208 may be secured within the cutout 206 via a fastener or the like. In some instances, the trim piece/fascia 208 may be press fit within the cutout 206.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A knife, comprising:
a blade comprising a first end, a second end, a top portion, and an opposed bottom portion;
a spine disposed along the top portion; and
a cutout disposed on the spine.

2. The knife of claim 1, further comprising a trim piece disposed within the cutout.

3. The knife of claim 2, wherein the trim piece is lighter than a material that forms a blade of the knife.

4. The knife of claim 3, wherein the trim piece is composed of a second material selected from the group consisting of plastic and carbon fiber.

5. The knife of claim 1, further comprising an open position and a closed position.

6. The knife of claim 5, further comprising a handle coupled to the second end of the blade, wherein the handle is configured to receive the blade.

7. The knife of claim 6, wherein the handle comprises a pivot point disposed between the blade and the handle, wherein the blade is configured to rotate about the pivot point.

8. The knife of claim 7, wherein the blade comprises an adjustment post, wherein in the closed position the adjustment post is positioned outside the handle.

9. The knife of claim 6, wherein the cutout and the trim piece shift the weight distribution of the knife towards the handle.

10. The knife of claim 6, wherein the blade comprises a tang coupled to the handle.

11. The knife of claim 6, wherein the handle comprises at least one scale.

12. The knife of claim 11, wherein the handle comprises two scales attached to opposing sides of the blade.

13. The knife of claim 12, wherein a plurality of rivets secure the two scales to the blade.

14. The knife of claim 1, further comprising a gripped surface disposed on the spine.

15. A knife, comprising:
a blade comprising a first end, a second end, a top portion, and an opposed bottom portion;
a spine disposed along the opposed bottom portion;
a cutout disposed on the opposed bottom portion;
a handle coupled to the blade; and
a trim piece disposed within the cutout, wherein the cutout and the trim piece shift the weight distribution of the knife towards the handle of the knife.

16. The knife of claim 15, wherein the blade comprises a gripped surface on the spine.

17. The knife of claim 15, wherein the handle comprises at least one scale.

18. The knife of claim 17, wherein a plurality of rivets secure the at least one scale to the blade.

19. The knife of claim 15, wherein the blade comprises a thang coupled to handle.

20. A knife, comprising:
a blade comprising a first end, a second end, a top portion, and an opposed bottom portion;
a spine disposed along the opposed bottom portion;
an adjustment post disposed on the blade;
a cutout disposed on the opposed bottom portion;
at least one scale coupled to the blade; and
a trim piece disposed within the cutout, wherein the cutout and the trim piece shift the weight distribution of the knife towards the at least one scale.
